(19) United States
(12) Patent Application Publication
(10) Pub. No.: US 2015/0123317 A1
(43) Pub. Date: May 7, 2015

(54) METHODS OF LASER SCORING MULTI-LAYER FILMS AND RELATED STRUCTURES

(71) Applicant: EXOPACK TECHNOLOGIES, LLC, Spartanburg, SC (US)

(72) Inventors: Marc David Sorem, Menasha, WI (US); Josh Benjamin Ball, Menasha, WI (US)

(21) Appl. No.: 14/390,965

(22) PCT Filed: Mar. 14, 2013
(86) PCT No.: PCT/US2013/031693

§ 371 Date: Oct. 6, 2014

Related U.S. Application Data
(60) Provisional application No. 61/621,328, filed on Apr. 6, 2012.

(51) Int. Cl. B23K 26/40

(52) U.S. Cl. CPC B23K 26/409; B23K 26/4065
USPC 264/400

(57) ABSTRACT

The present disclosure relates to methods of scoring packaging structures, including multi-layer polymeric films incorporating an encapsulated oxygen-impermeable layer, using laser energy. The methods are able to score structures which contain an oxygen-impermeable barrier without disrupting the permeability characteristics of the structure, and retain good printability, clarity, and gloss.

### CROSS-REFERENCE TO RELATED APPLICATIONS

This application claims the benefit of U.S. Provisional Application No. 61/621,328 filed on Apr. 6, 2012, titled METHODS OF LASER SCORING MULTI-LAYER FILMS AND RELATED STRUCTURES, which is herein incorporated by reference in its entirety.

### TECHNICAL FIELD

The present disclosure relates to scoring multi-layer polymeric films and related structures using laser energy. Such scored structures may be used in the packaging industry

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1A shows an exemplary film structure, according to an embodiment of the present disclosure.

FIG. 1B shows an exemplary film structure, according to another embodiment of the present disclosure.

FIG. 1C shows an exemplary film structure, according to another embodiment of the present disclosure.

FIG. 1D shows an exemplary film structure, according to another embodiment of the present disclosure.

FIG. 2A shows an exemplary scored film structure, according to an embodiment of the present disclosure.

FIG. 2B shows an exemplary scored film structure, according to another embodiment of the present disclosure.

FIG. 2C shows an exemplary scored film structure, according to a further embodiment of the present disclosure.

FIG. 3 shows an exemplary apparatus used for laser scoring a film structure, according to an embodiment of the present disclosure.

FIG. 4 is a micrograph of an exemplary scored film, according to an embodiment of the present disclosure.

FIG. 5 is a micrograph of an exemplary scored film, according to another embodiment of the present disclosure.

### DETAILED DESCRIPTION

Polymers may be used as barrier materials to prevent the passage of gases, such as oxygen and water vapor, from one side of a film structure to the other. Film structures which contain such barrier layers are desirable for various packaging applications, including food packages. Providing a package to consumers which may be both initially opened easily and also where the opening is expanded across the package in a controlled manner, i.e. in order not to tear, rip, or otherwise damage the structural integrity of the package material, is an ongoing challenge for packaging manufacturers. Providing an easily opened controlled-tear package made of a film structure which contains gas-impermeable barrier materials, is also challenging, as such barrier materials often lose their integrity under conventional cutting or scoring conditions. In addition, the package must also retain good printability, clarity, and gloss characteristics that can withstand the cutting or scoring process. The packaging must also be cost-effectively manufactured.

The present disclosure relates to methods of scoring packaging structures, including multi-layer polymeric films incorporating an encapsulated oxygen-impermeable layer, using laser energy. The methods are able to score film structures which contain an oxygen-impermeable barrier without disrupting the permeability characteristics of the structure, and retain good printability, clarity, and gloss.

Moreover, although the disclosure describes examples relative to film structures which contain an encapsulated gas-impermeable barrier, certain features, apparatus, and methods disclosed herein may be applied suitably to other structures. For example, as further discussed below, embodiments of the present disclosure may include one or more features of film structures which do not contain an encapsulated gas-impermeable barrier.

In some embodiments, the laser scoring may be useful for paper-containing structures. Accordingly, as used herein, the term “film structure” includes structures containing both polymeric and paper layers, or structures containing only paper or only polymeric layers.

The embodiments disclosed herein will become more fully apparent from the following description and appended claims, taken in conjunction with the accompanying drawings. These embodiments will be described with additional specificity and detail through use of the accompanying drawings.

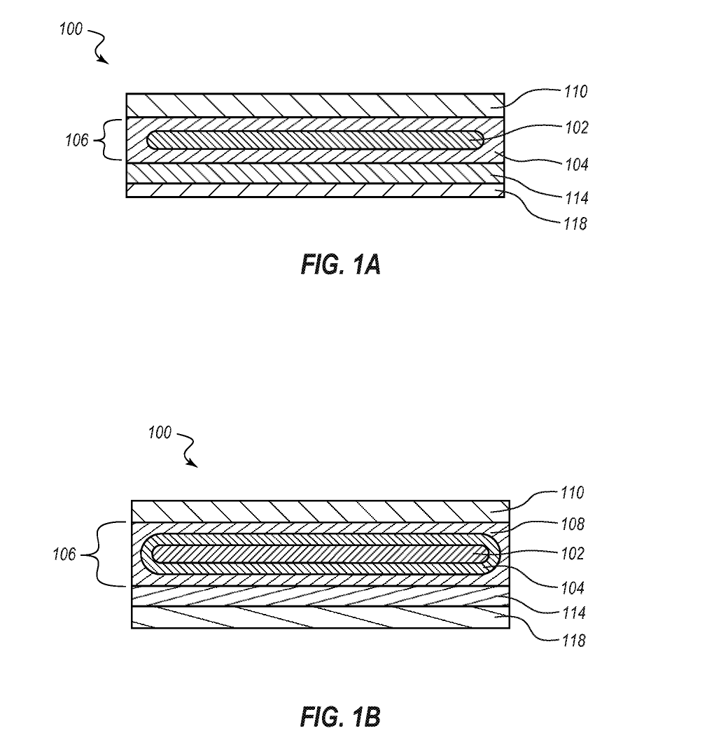

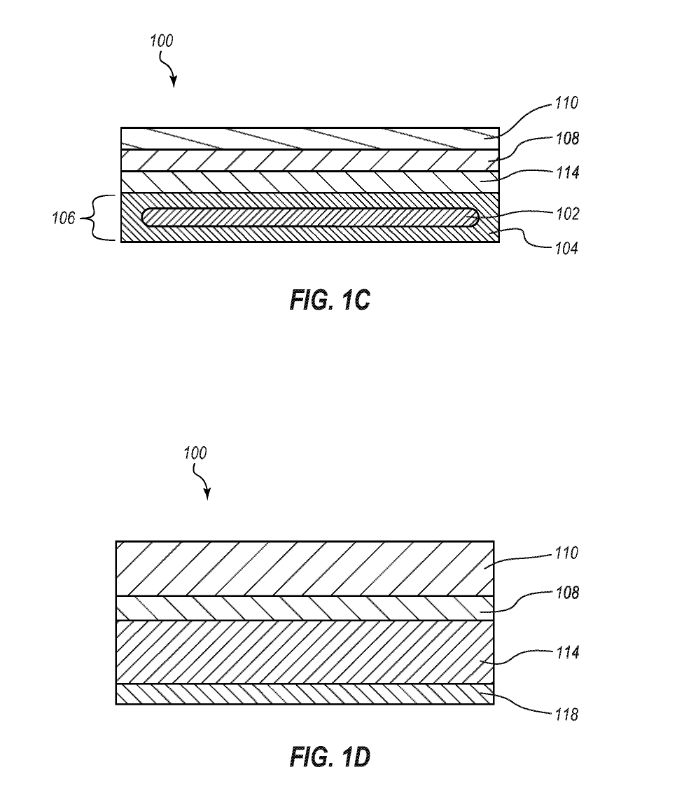

Exemplary film structures 100 that may be scored in accordance with aspects of the present disclosure are shown in FIGS. 1A-1D. As shown in FIG. 1A, the film structure 100 may comprise a first outer layer 110, a second outer layer 118, and a barrier layer 102. Alternatively, in some embodiments, the film structure 100 may not include a barrier layer 102. In yet other embodiments, the film structure 100 may comprise a plurality of barrier layers 102. The barrier layer 102 may be disposed between the first outer layer 110 and the second outer layer 118. As can be appreciated, however, the barrier layer 102 may be disposed such that it is an outer layer of the film structure 100.

In some embodiments, the barrier layer 102 may serve as a barrier to elements such as grease, moisture, liquids and gases. In certain embodiments, the barrier layer 102 may comprise polymers and copolymers of ethylene vinyl alcohol (“EVOH”). In other embodiments, the barrier layer 102 may comprise blends of nylon, polyethylene, or EVOH, or combinations thereof. In yet other embodiments, the barrier layer 102 may comprise any thermoplastic polymeric material that is gas impermeable and can block or serve as a barrier to elements such as oxygen or water vapor, including but not limited to polyamide polymers, copolymers or blends thereof; polyvinylidene chloride (“PVdC”) or polyvinylidene chloride/methyl acrylate (“PVdC-MA”); acrylonitrile polymers or copolymers; or polyethylene copolymers or blends.

In certain embodiments, the barrier layer 102 may optionally be encapsulated by one or more encapsulation materials 104 to form an encapsulation layer 106. A variety of materials may be used as encapsulation materials 104. For example, the encapsulation materials 104 may comprise acid terpolymers; nylon; polyethylene; maleic anhydride grafted to polyethylene; ethylene methyl acrylate copolymers; ethylene vinyl acetate copolymers; or polystyrene block copolymers. In some embodiments, an encapsulation material 104 comprises an acid terpolymer of, for example, ethylene, acrylic acid and methyl acrylate, e.g., a tie layer. In certain embodiments, the encapsulation material 104 comprises polyethylene, including low density polyethylene. In an embodiment, the encapsulation material 104 comprises a polyethylene layer and an acid-modified ethylene terpolymer layer.

The encapsulation material 104 may be used to encapsulate barrier layers 102 comprising at least one of EVOH; EVOH/nylon blends; EVOH/polyethylene copolymers; polyamides or acrylonitrile. In other embodiments, an encapsulation material 104 comprising polyethylene may be used to encapsulate barrier layers 102 comprising at least one of EVOH, EVOH/nylon blends, EVOH/polyethylene copolymers, or polyamide. In yet other embodiments, an encapsulation material 104 comprising polyethylene or maleic anhydride grafted to polyethylene may be used to encapsulate barrier layers 102 comprising at least one of EVOH, EVOH/nylon blends, EVOH/polyethylene copolymers, polyamides, or PVdC-MA. In yet other embodiments, an encapsulation material 104 comprising a polystyrene block copolymer may be used to encapsulate barrier layers 102 comprising acrylonitrile. In certain embodiments, an encapsulation material 104 comprising ethylene acrylic acid copolymer may be used to encapsulate barrier layers 102 comprising PVdC-MA or acrylonitrile. In an embodiment, an encapsulation material 104 comprising polyethylene, including low density polyethylene, may be used to encapsulate barrier layers 102 comprising EVOH.

As shown in FIG. 1A, the film structure 100 may optionally include one or more inner layers 114, disposed between the first outer layer 110 and the second outer layer 118. These inner layers 114 may provide the film structure 100 with enhanced characteristics and properties. In an embodiment, an inner layer 114 may be a moisture barrier layer such as, for example, oriented polypropylene.

The barrier layer 102 and inner layers 114 may be arranged in a variety of ways. For example, one or more inner layers 114 may be disposed between a barrier layer 102 and an outer layer 110 of the film structure 100. Alternatively, one or more inner layers 114 may be disposed between a barrier layer 102 and an outer layer 118 of the film structure 100. Alternatively, in some embodiments, there may be no inner layers 114 disposed between the barrier layer 102 and an outer layer 110, 118 of the film structure 100.

As shown in FIG. 1A, in some embodiments, there may be no inner layers 114 disposed between a first side of the barrier layer 102 and a first outer layer 110 of the film structure 100, while there may be one or more inner layers 114 disposed between a second side of the barrier layer 102 and a second outer layer 118 of the film structure 100. Accordingly, the barrier layer 102 and one or more inner layers 114 may be arranged in any manner depending on the desired film structure 100. In certain embodiments, there may be tie layers inserted between any of the layers, to aid in forming the film structure 100.

The non-encapsulation layers of the film structure 100, including for example, outer layers 110, 118 and inner layers 114, may comprise a variety of materials including, for example, polymers and copolymers of polyester, polymers and copolymers of polyolefins including, for example, polyethylene, polyethylene terephthalate, polypropylene, ethylene vinyl acetate, polymers and copolymers of polyamide such as nylon, cellophane, ethylene terpolymers, paper materials, or combinations or blends thereof. As can be appreciated, polypropylene layers may be oriented or non-oriented, and may be woven. In certain embodiments, the inner layer 114 may comprise polyproplylene, including an oriented polypropylene such as biaxially oriented polypropylene. In some embodiments, the inner layer 114 is a moisture barrier layer.

In certain embodiments, layers comprising polypropylene can exhibit relatively high grease-resistance, rigidity, translucence, chemical resistance, toughness, fatigue resistance, integral hinge properties, and/or heat resistance. Various forms of polypropylene are possible, including random copolymers and homopolymers, and may be selected based on particular needs and cost considerations.

In some embodiments, at least one non-encapsulation layer (e.g., 110, 114, 118) may comprise polymeric materials, and at least one non-encapsulation layer (e.g., 110, 114, 118) may comprise paper materials. Accordingly, in certain embodiments, the film structure 100 may comprise a combination of polymeric and paper materials. In other embodiments, each non-encapsulation layer (e.g., 110, 114, 118) may comprise polymeric materials. In yet other embodiments, each non-encapsulation layer (e.g., 110, 114, 118) may comprise paper materials.

The non-encapsulation layers (e.g., 110, 114, 118) of the film structure 100 may further comprise materials that add strength, stiffness, heat resistance, durability, printability or other enhanced characteristics to the film structure 100. For example, certain film structures 100 may include one or more non-encapsulation layers (e.g., 110, 114, 118) that are puncture-resistant, tear-resistant, scratch-resistant, grease-resistant, moisture resistant, and/or absorption-resistant. In some embodiments, one or more non-encapsulation layers (e.g., 110, 118) may serve as a sealant layer. The sealant layer may be a heat-sealant layer that may form a seal when heat and/or pressure is applied to the film structure 100. Accordingly, the non-encapsulation layers (e.g., 110, 114, 118) may comprise any material apparent to those skilled in the art for providing desired characteristics to the film structure 100.

Moreover, in some embodiments, one or more non-encapsulation layers (e.g., 110, 114, 118) may serve as a protective layer. The protective layer may, for example, protect the barrier layer 102 and/or the encapsulation layer 106 from being damaged or punctured. In certain embodiments, one or more protective layers may protect the barrier layer 102 and/or the encapsulation layer 106 from being scored by a laser. In some embodiments, a protective layer may therefore comprise a material that will not melt or vaporize upon exposure to a laser. In other embodiments, a protective layer may comprise a material that will melt and/or weaken upon exposure to a laser, but will not vaporize. Accordingly, the film structure 100 may be weakened along laser score lines, but not cut completely through. Such an embodiment may allow for a film structure 100 that is easily torn or opened on the weakened laser score lines.

In certain embodiments within the scope of this disclosure, the laser score may penetrate the encapsulation material, including encapsulation layers 104, 108, and a portion of the barrier layer 102, wherein the uncut portion of the barrier layer 102 remains sufficiently and/or substantially gas-impermeable. In an embodiment, the uncut portion of the barrier layer 102 is about 90% of the original thickness of the layer 102. In some embodiments, the uncut portion of the barrier layer may be between about 10% and about 90% of the original thickness; or it may be between about 20% and about 80%; or it may be at least about 10%; or it may be no more than about 90%.

As used herein, when referring to the gas impermeability of a scored or partially scored barrier layer 102 as remaining “substantially” gas-impermeable, the term “substantially” means that the barrier layer 102 retains at least 50% of the gas-impermeability of a non-scored layer. In certain embodiments, substantially means that the scored or partially scored barrier layer 102 retains at least about 95%, at least about 90%, at least about 80%, at least about 75% or at least about 60% of the gas-impermeability of a non-scored layer. In some embodiments, substantially means that the barrier layer 102 loses no more than about 5%, no more than about 10%, no more than about 15%, no more than about 20%, no more than about 25% or no more than about 40% of the gas-impermeability of a non-scored layer. For a scored or partially scored barrier layer 102, the properties of the layer may not necessarily be altered commensurately in proportion to the amount of scoring through the layer.

In other embodiments, one or more encapsulation materials 104 may serve as a protective layer to protect the barrier layer 102 from being damaged, punctured, or scored by a laser. An encapsulation material 104 may therefore comprise a material that will not melt or vaporize upon exposure to a laser. Alternatively, the encapsulation material 104 may comprise a material that is melted or vaporized entirely, or partially, upon exposure to a laser.

The barrier layer 102, encapsulation material 104, and non-encapsulation layers (e.g., 110, 114, 118) may be joined in any suitable fashion. For example, in some embodiments, additional materials may be utilized in the film structure 100 to act as adhesive or tie layers to co-extrude with, laminate to, or otherwise be disposed between the barrier layer 102, encapsulation material 104, and non-encapsulation layers (e.g., 110, 114, 118). The adhesive or tie layer may comprise a solvent-based or solventless adhesive, a plastic-type bonding material, or a coextruded film. In some embodiments, the adhesive or tie layer comprises polyurethane. In other embodiments, the adhesive or tie layer may include a component selected from the group consisting of styrene-isoprene-styrene copolymers, styrene-butadiene-styrene copolymers, ethylene ethyl acrylate copolymers, polyurethane reactive adhesives, tackifiers, waxes, paraffin, antioxidants, plasticizers, plant sterols, terpene resins, polyterpene resins, turpentines, hydrocarbon resins, resin acids, fatty acids, polymerized rosins, rosin esters, and polyamide adhesives. The adhesive or tie layer may be a hot melt adhesive. In certain embodiments, the adhesive or tie layer is an ethylene terpolymer.

One or more layers of the film structure 100 may optionally be treated with a coating. The coating may protect against abrasion of the film structure 100, and may provide an aesthetically appealing gloss finish. In some embodiments, the coating may facilitate adhesion and bonding and may increase a coefficient of friction of the film structure 100. In some embodiments, the coating may include printed indicia, which may be surface printed or reverse printed. Procedures for printing indicia may include process printing, rotogravure printing, and innovative flexographic printing. In an embodiment, the coating may comprise, for example, a flexography coating, a proprietary coating, or any other suitable coating.

In some embodiments, the film structure 100 may exhibit a high modulus (e.g., modulus of elasticity) such that it is able to elastically stretch. Such a film structure 100 can provide resiliency, which can help prevent rips, tears, or punctures.

The film structures 100 of the present disclosure may vary in thickness. For example, in one embodiment, the film structure 100 may have a thickness of between about 0.5 and about 10 mils. In another embodiment, the film structure 100 may have a thickness of between about 1 and about 5 mils. In other embodiments, the film structure 100 may have a thickness of between about 2 and about 4.5 mils, or between about 2.5 and about 4 mils. The film structure 100 may vary in thickness depending on the desired characteristics of the film structure.

The thickness of the barrier layer 102 and encapsulation material 104 may also vary depending on the desired characteristics of the film structure 100. In an embodiment, the barrier layer 102 has a thickness of between about 0.05 and about 5 mils. In another embodiment, the barrier layer 102 has a thickness of between about 0.05 and about 0.35 mils. In other embodiments, the barrier layer 102 has a thickness of between about 0.1 and about 0.3 mils, or is about 0.2 mils.

In an embodiment, the encapsulation material 104 that encapsulates the barrier layer 102 has a thickness of between about 0.05 and about 3 mils for each layer surrounding the barrier layer 102. In another embodiment, each layer of the encapsulation material 104 that encapsulates the barrier layer 102 has a thickness of between about 0.1 and about 0.3 mils. In other embodiments, each layer of the encapsulation material 104 that encapsulates the barrier layer 102 has a thickness of between about 0.3 and about 0.5 mils.

FIG. 1B is an exemplary film structure 100, according to another embodiment of the present disclosure. As shown in FIG. 1B, the film structure 100 may comprise a first outer layer 110, a second outer layer 118, encapsulated material 106, and at least one inner layer 114. As further shown in FIG. 1B, the encapsulated material 106 may comprise a barrier layer 102 encapsulated by a first encapsulation material 104 and a second encapsulation material 108. In other embodiments, the barrier layer 102 may be further encapsulated by additional (e.g. a third, or a third and fourth) encapsulation layers 104, 108. Accordingly, the barrier layer 102 may be encapsulated by a plurality of encapsulation layers depending on the desired characteristics of the film structure 100.

FIG. 10 is an exemplary film structure 100, according to another embodiment of the present disclosure. As shown in FIG. 10, the film structure 100 may comprise a first outer layer 110, an encapsulation layer 106 comprising a barrier layer 102 encapsulated by a first encapsulation material 104, a first inner layer 114, and a second inner layer 108. Moreover, as depicted in the illustrated embodiment of FIG. 10, the encapsulation layer 106 may be disposed such that it is a second outer layer of the film structure 100. Accordingly, the layers of the film structure 100 may be arranged in any manner depending on the desired characteristics of the film structure 100.

FIG. 1D is an exemplary film structure 100, according to another embodiment of the present disclosure. As shown in FIG. 1D, in certain embodiments, the film structure 100 may comprise a first outer layer 110, a second outer layer 118, and inner layers 108 and 114. In some embodiments, an inner layer may be a barrier layer, including a moisture barrier layer or an oxygen-impermeable layer. As depicted in the illustrated embodiment of FIG. 1D, the film structure 100 may optionally not comprise an encapsulated structure. In another embodiment, the film structure 100 may not comprise a barrier layer. As can be appreciated, the film structure 100 may therefore be composed of any combination of the layers previously discussed.

In certain embodiments, the film structure 100 comprises a first outer layer 110 comprising at least one of polyethylene or nylon, an inner layer 108 comprising polyethylene, which may be low density polyethylene, an inner layer 114 comprising polypropylene, which may be biaxially oriented, and a second outer layer 118 comprising ethylene vinyl acetate. In some embodiments, the inner layer 108 is between the first outer layer 110 and the inner layer 114.

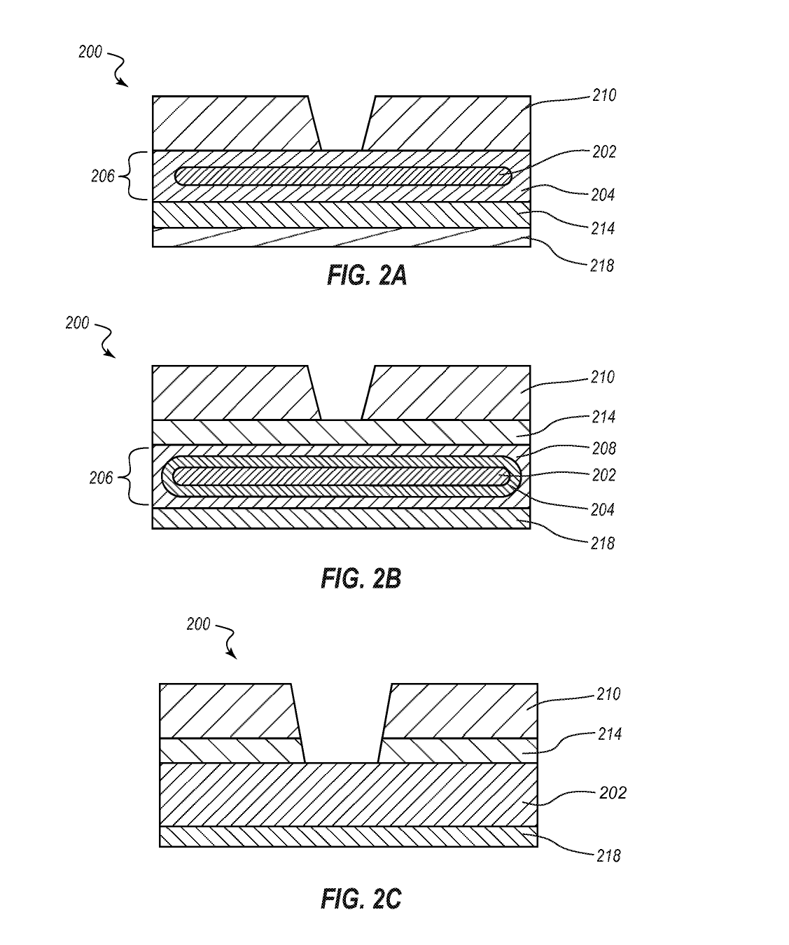

FIGS. 2A-2C are exemplary film structures 200 that have been scored by a laser in accordance with the present disclosure. The film structures 200 can, in certain respects, resemble components of the film structures described in connection with FIGS. 1A-1D above. It will be appreciated that all the illustrated embodiments may have analogous features. Accordingly, like features are designated with like reference numerals, with the leading digits incremented to “2.” (For instance, the film structures are designated “100” in FIGS. 1A-1D, and analogous film structures are designated as “200” in FIGS. 2A-2C.) Relevant disclosure set forth above regarding similarly identified features thus may not be repeated hereafter. Moreover, specific features of the film structures and related components shown in FIGS. 2A-2C may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the film structures of FIGS. 2A-2C. Any suitable combination of the features, and variations of the same, described with respect to the film structures 100 and components illustrated in FIGS. 1A-1D, can be employed with the film structures 200 and components of FIGS. 2A-2C, and vice versa. This pattern of disclosure applies equally to further embodiments depicted in subsequent figures and described hereafter.

FIG. 2A is an exemplary film structure 200 that has been scored by a laser according to an embodiment of the present disclosure. As shown in FIG. 2A, a film structure 200 may comprise a first outer layer 210, a second outer layer 218, an encapsulation layer 206 comprising a barrier layer 202 encapsulated by a first encapsulation material 204, and an inner layer 214. In the illustrated embodiment of FIG. 2A, outer layer 210 has been scored by a laser. The encapsulation layer 206, however, has not been scored by a laser and has remained substantially unchanged. The second outer layer 218 and the inner layer 214, each disposed on a side of the encapsulation layer 206 that is opposite to the side wherein outer layer 210 is disposed, also remain unscored and substantially unchanged.

As previously discussed, in some embodiments, an encapsulation material 204 may serve as a protective layer that will not melt or vaporize upon exposure to a laser. Accordingly, as shown in FIG. 2A, the encapsulation layer 206 and barrier layer 202 may remain substantially unchanged while an outer layer 210 may be scored by a laser. In other embodiments, one or more additional layers may serve as protective layers to stop the laser from scoring into the encapsulation layer 206 or completely through the film structure 200. In other embodiments, the film structure 200 may be scored such that the laser may score through each layer of the film structure, including an encapsulation layer 206 comprising a barrier layer 202.

As previously discussed, in certain embodiments within the scope of this disclosure, the laser score may penetrate the encapsulation material, wherein the uncut portion of the barrier layer 202 remains sufficiently and/or substantially gas-impermeable. In one embodiment, the uncut portion of the barrier layer 202 is about 90% of the original thickness of the layer 202. In some embodiments, the uncut portion of the barrier layer may be between about 10% and about 90% of the original thickness; or it may be between about 20% and about 80%; or it may be at least about 10%; or it may be no more than about 90%.

As previously discussed, when referring to the gas impermeability of a scored or partially scored barrier layer 202 as remaining “substantially” gas-impermeable, the term “substantially” means that the barrier layer 202 retains at least 50% of the gas-impermeability of a non-scored layer. In certain embodiments, substantially means that the scored or partially scored barrier layer 202 retains at least about 95%, at least about 90%, at least about 80%, at least about 75% or at least about 60% of the gas-impermeability of a non-scored layer. In some embodiments, substantially means that the barrier layer 202 loses no more than about 5%, no more than about 10%, no more than about 15%, no more than about 20%, no more than about 25% or no more than about 40% of the gas-impermeability of a non-scored layer. For a scored or partially scored barrier layer 202, the properties of the layer may not necessarily be altered commensurately in proportion to the amount of scoring through the layer.

FIG. 2B is another exemplary film structure 200 that has been scored by a laser according to an embodiment of the present disclosure. As shown in FIG. 2B, a film structure 200 may comprise a first outer layer 210, a second outer layer 218, an encapsulation layer 206 comprising a barrier layer 202 encapsulated by a first encapsulation material 204 and a second encapsulation material 208, and an inner layer 214. In the illustrated embodiment of FIG. 2B, outer layer 210 has been scored by a laser. The inner layer 214, the encapsulation layer 206, and outer layer 218, however, have not been scored by a laser.

As previously discussed, in some embodiments, inner layer 214 may serve as a protective layer that will not melt or vaporize upon exposure to a laser. Accordingly, as shown in FIG. 2B, the inner layer 214, the encapsulation layer 206 comprising a barrier layer 202, and outer layer 218 may each remain intact while the outer layer 210 may be scored by a laser.

In some embodiments, the laser scoring of the exemplary film structure 200 generally lies in a plane substantially perpendicular to a plane of the layers within the multi-layer film, as the multilayer film is depicted in the Figures (i.e. orthogonal to the surface normal of the layers).

FIG. 2C is another exemplary film structure 200 that has been scored by a laser according to an embodiment of the present disclosure. As shown in FIG. 2C, a film structure 200 may comprise a first outer layer 210, a second outer layer 218, an inner layer 214, and a barrier layer 202. In the illustrated embodiment of FIG. 2C, outer layer 210, and the inner layer 214 have each been scored by a laser. The barrier layer 202 and outer layer 218, however, have not been scored by a laser and each remain substantially intact.

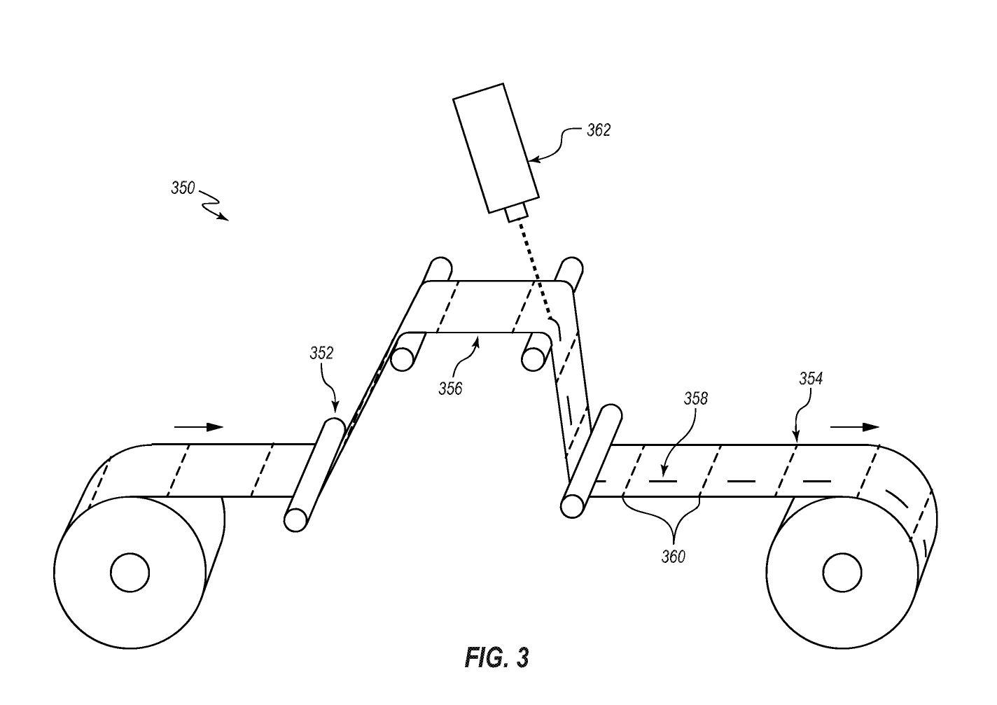

FIG. 3 shows an exemplary apparatus 350 for scoring a multi-layer film 356. The apparatus may include one or more rollers 352 along the path of which the film 356 travels. The film 356 may include one or more perforations 354. The film 356 may be segmented in, for example, separate sections or segments 360 defined between consecutive perforations 354. The perforations 354 may be made using a laser 362 or by any other method for perforating films. The perforations 354 may enable the film structure 356 to be torn in a controlled manner such that the structural integrity of the film 356 is not otherwise damaged. Segments 360 of the film 356 may, for example, be used to make individual bags. In an embodiment, the perforations 354 may comprise a single continuous line of weakened film structure.

In some embodiments, the apparatus 350 includes a single laser 362 that may be used to score the film 356. The laser 362 may be in a fixed position relative to the film 356 that is being scored. Alternatively, the apparatus 350 may be configured in such way that the laser 362 is allowed to rotate and/or move in vertical and horizontal directions. In other embodiments, a plurality of lasers 362 may be used.

In certain embodiments, a plurality of lasers 362 may be used to score the film 356 either simultaneously or independently of one another. For example, in some embodiments, five, or up to ten lasers 362 may be used to score the film structure 356. The plurality of lasers 362 may be in a fixed position relative to the film 356 that is being scored, or allowed to rotate and/or move in vertical and horizontal directions. Beam splitters may also be used to split the beam from a laser 362 into one or more laser beams for use in the present disclosure.

The laser 362 may score a film structure 356 being drawn in the machine direction. Alternatively, the laser 362 may score a film structure 356 being drawn in the transverse, or cross-machine direction. Alternatively, in some embodiments, the laser 362 may score a film structure 356 at an angle that is between the machine direction and cross-machine direction.

The laser score 358 may be continuous or discontinuous. A continuous laser beam may be used to create a continuous score 358 on the film 356. Alternatively, a discontinuous laser beam can be used to create a discontinuous, perforated or dashed score line 358 on the film 356.

In some embodiments, there is only one laser score 358 per segment 360 of film 356 defined by consecutive perforations 354. In other embodiments, there may be a plurality of laser scores 358 per segment 360 of the film 356. The plurality of laser scores 358 may be parallel to each another. For example, there may be two parallel laser scores 358 on a segment 360 of film 356, such that the laser scores 358 may align with one another when the segment 360 of film 356 is folded in half, for example, to form the sides of an individual package.

The output power of the laser 362 may vary depending on the thickness of the film 356 being scored. For example, higher wattages may be needed for thicker films 356, whereas lower wattages may be needed for thinner films 356. In certain embodiments, the output power is dependent upon the type of material that is in the film structure 356 being scored. For example, relatively higher wattages may be needed to score films 356 comprising materials with relatively high melting points, whereas relatively lower wattages may be needed to score films 356 comprising materials with relatively low melting points. Alternatively, the output power of the laser 362 may be dependent on different physical parameters of the film structure 356, or dependent upon a physical parameter of a specific layer within the film structure 356.

The output power of the laser 362 may also be dependent upon the rate that the film 356 travels through the laser beam, i.e., the exposure time of the laser beam to the film 356. For example, relatively higher wattages may be needed for films 356 that are traveling through the laser beam at a relatively higher rate, as any given area of the film 356 may be subjected to the laser beam for a relatively short amount of time.

In certain embodiments, it may be desirable that the scored film structure retain sufficient strength such that the film is not easily torn or broken when stretched. The strength of the scored film structure can be classified in a variety of ways, including by the film structure's tensile strength. Various methods of measuring tensile strength of film structures are known. In one method, for example, two opposite sides of the film structure are gripped by a gripping mechanism and pulled in opposite directions until the film structure breaks. The film structures disclosed herein are analyzed using an Instron tensile test method pulled at two inches per minute, as described in ASTM #D-882. The amount of force required to break the film structure may be classified as the film structure's maximum load. Another strength parameter is the extension of the film at the break point, which may be measured in inches.

The desired tensile strength at the location of the score may be dependent upon the desired use of the film. In some embodiments, it may be desirable to have a tensile strength of between about 3 to about 30 lbf at the location of the score. In other embodiments, it may be desirable to have a tensile strength of between about 5.5 to about 12 lbf, or between about 6 to about 10 lbf, at the location of the score. Having a tensile strength of between about 3 to about 20 lbf may provide an easy-tear at the location of the score in a film structure.

The depth and width of the laser score can affect the film structure's tensile strength at the location of the score. For example, a deep laser score may cause the tensile strength at the location of the score to be relatively low. Moreover, a wide laser score also may cause the tensile strength at the location of the score to be relatively low. Conversely, a shallow or narrow laser score is expected to result in a relatively high tensile strength at the location of the score.

The depth and width of the laser score can also affect the film structure's permeability properties. For example, a relatively deep or wide laser score may alter the film's gas impermeability properties. In certain embodiments, it may be desirable that the scored film structure retain its gas impermeability properties such that the gas impermeability of the film at the location of the score is substantially the same as the impermeability of the film at a non-scored location. Accordingly, it may be desirable that a barrier layer of the scored film retains its gas permeability characteristics. In some embodiments, it may be may be desirable that a barrier layer of the scored film loses its gas permeability characteristics upon scoring.

The permeability of the film structure may be measured by the film structure's oxygen transmission rate (“OTR”). The OTR is a measurement of the amount of oxygen gas that passes through the film structure over a given period of time, and is measured herein using the process described in ASTM #D-3985. In some embodiments, it may be desirable that the OTR of the scored film structure be less than about 2.00 ml/100 in²/24 hour. In an embodiment, the OTR of the scored film structure be less than about 1.00 ml/100 in²/24 hour. In other embodiments, it may be desirable that the OTR of the scored film structure be between about 0.05 and about 12.0 ml/100 in²/24 hour. In other embodiments, it may be desirable that the OTR of the scored film structure be between about 0.50 and about 2.0 ml/100 in²/24 hour, or between about 0.8 and about 2.0 ml/100 in²/24 hour. In yet other embodiments, it may be desirable that the OTR of the scored film structure be between about 0.75 and about 1.5 ml/100 in²/24 hour, between about 1.1 and about 1.5 ml/100 in²/24 hour, or no greater than about 2.0 ml/100 in²/24 hour.

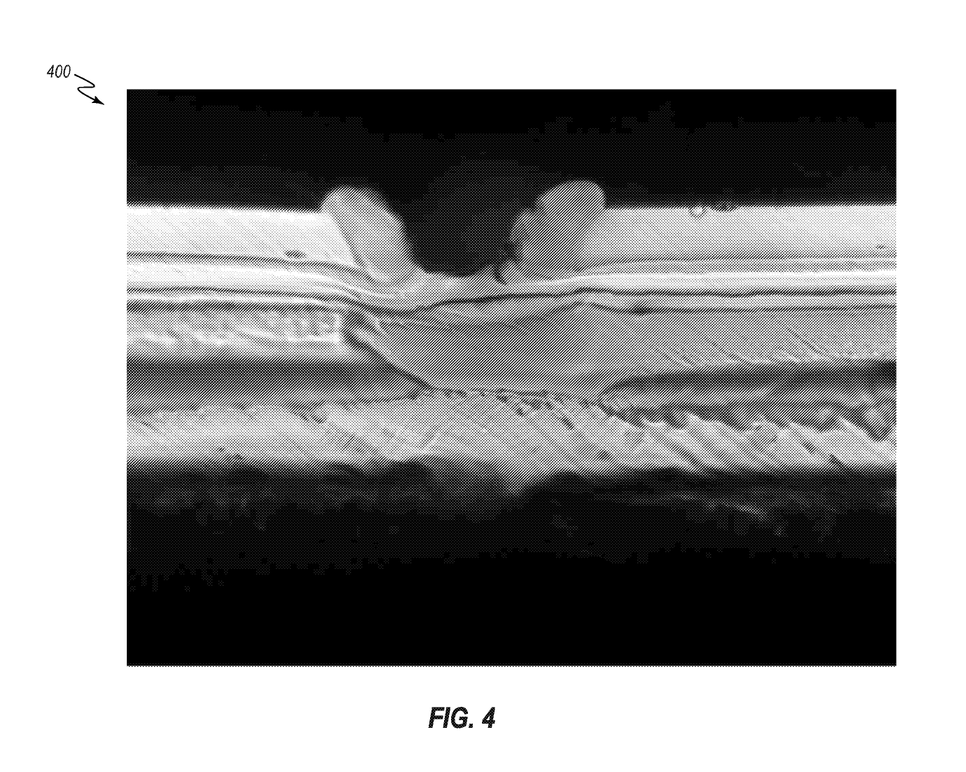

FIG. 4 shows a micrograph, taken at about 50× magnification, of an exemplary scored film structure 400 that has been scored according to an embodiment of the present disclosure. The film structure 400 comprises a first outer layer comprising about 48 gauge biaxially oriented nylon disposed adjacent to a first side of an encapsulation layer; the encapsulation layer comprising an EVOH barrier layer coextruded with an encapsulation material comprising polyethylene; an inner layer comprising about 55 gauge oriented polypropylene disposed adjacent a second side of the encapsulation layer; and a second outer layer comprising ethylene vinyl acetate disposed adjacent the oriented polypropylene layer. The EVOH coextruded with polyethylene was about 8.7 lb/ream. The ethylene vinyl acetate layer was about 1.0 mil thick and was about 14 lb/ream. The total thickness of the film structure was about 2.6 mil. The film structure 400 was scored using about 45% laser power. As shown in FIG. 4, the first outer layer comprising biaxially oriented nylon was scored by the laser. The encapsulation layer comprising EVOH coextruded with polyethylene, the inner layer comprising oriented polypropylene, and the second outer layer comprising ethylene vinyl acetate were not scored by the laser and remained substantially unchanged.

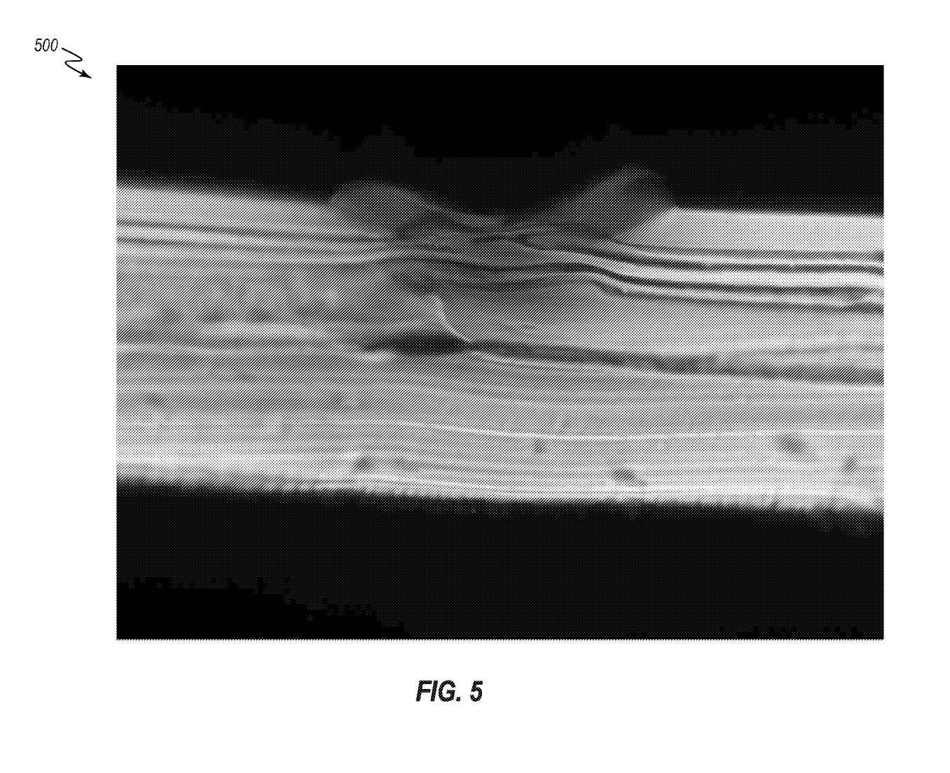

FIG. 5 shows a micrograph, taken at about 50× magnification, of an exemplary scored film structure 500 that has been scored according to an embodiment of the present disclosure. The film structure 500 comprises a first outer layer comprising about 36 gauge polyethylene terephthalate disposed adjacent a first side of an encapsulation layer; an encapsulation layer comprising an EVOH barrier layer coextruded with an encapsulation material comprising polyethylene; an inner layer comprising about 55 gauge oriented polypropylene disposed adjacent a second side of the encapsulation layer; and a second outer layer comprising ethylene vinyl acetate disposed adjacent the oriented polypropylene layer. The EVOH coextruded with polyethylene was about 8.7 lb/ream. The ethylene vinyl acetate layer was about 1.5 mil thick and was about 21 lb/ream. The film structure 500 was scored using about 40% laser power. As shown in FIG. 5, the first outer layer comprising polyethylene terephthalate was scored by the laser. The encapsulation layer comprising EVOH coextruded with polyethylene, the inner layer comprising oriented polypropylene, and the second outer layer comprising ethylene vinyl acetate were not scored by the laser and remained substantially unchanged.

### EXAMPLES

The following examples are illustrative of embodiments of the present invention, as described above, and are not meant to limit the invention in any way.

### Example 1

A multi-layer film was prepared having a first outer layer comprising nylon disposed adjacent a first side of the encapsulation layer; an encapsulation layer comprising an EVOH barrier layer with an encapsulation material comprising polyethylene and a tie layer of acid-modified ethylene terpolymer between the barrier layer and polyethylene layer; an inner layer comprising oriented polypropylene disposed adjacent a second side of the encapsulation layer; and a second outer layer comprising ethylene vinyl acetate disposed adjacent the inner layer. One set of film samples was prepared with 5 duplicate pieces of film. Each film sample was approximately 2.6 mils thick. Each sample of film was scored with a LasX Industries LDM 100-5 model laser at about 45% laser power. Each sample was scored with continuous straight lines in two separate locations. One laser score was approximately 3 inches from the top of the film unit (the “upper” score), and the other laser score was approximately 4.5 inches from the top of the film unit (the “lower” score). The samples were analyzed for tensile strength using an Instron instrument model number 3369 and pulled at 2 inches per minute. The results are shown below in Table 1:

TABLE 1
Tensile Strength for the films of Example 1

| | Upper Score | Upper Score | Lower Score | Lower Score |
|---|---|---|---|---|
| | maximum | extension at | maximum | extension at |
| | load (lbs of | break | load (lbs of | break |
| Sample No. | force) | (inches) | force) | (inches) |
| 1 | 6.88 | 0.04 | 10.05 | 0.07 |
| 2 | 6.98 | 0.04 | 9.83 | 0.05 |
| 3 | 6.72 | 0.04 | 9.34 | 0.04 |
| 4 | 6.68 | 0.04 | 9.58 | 0.05 |
| 5 | 6.12 | 0.03 | 9.96 | 0.07 |
| average | 6.68 | 0.04 | 9.75 | 0.06 |

As shown in Table 1, the laser score in the “lower” score position had a higher maximum load and longer extension at break than the laser score in the “upper” score position.

### Example 2

The film of Example 1 was used to prepare an additional set of film samples with 5 duplicate pieces of film. Each sample of film was scored with a LasX Industries LDM 100-5 model laser at about 42% laser power. Each sample was scored with continuous straight lines in two separate locations. One laser score was approximately 3 inches from the top of the film unit (the “upper” score), and the other laser score was approximately 4.5 inches from the top of the film unit (the “lower” score). The samples were analyzed for tensile strength using an Instron instrument model number 3369 and pulled at 2 inches per minute. The results are shown below in Table 2:

TABLE 2
Tensile Strength for the films of Example 2

| | Upper Score | Upper Score | Lower Score | Lower Score |
|---|---|---|---|---|
| | maximum | extension at | maximum | extension at |
| | load (lbs of | break | load (lbs of | break |
| Sample No. | force) | (inches) | force) | (inches) |
| 1 | 8.58 | 0.05 | 9.84 | 0.07 |
| 2 | 8.37 | 0.05 | 10.27 | 0.06 |
| 3 | 8.35 | 0.05 | 9.21 | 0.04 |
| 4 | 8.20 | 0.04 | 9.61 | 0.05 |
| 5 | 7.89 | 0.06 | 10.78 | 0.06 |
| Average | 8.28 | 0.05 | 9.94 | 0.06 |

As shown in Table 2, the laser score in the “lower” score position had a higher maximum load than the laser score in the “upper” score position.

### Example 3

The two sets of the film samples of Example 1 (Sample A) and Example 2 (Sample B) were also tested for oxygen permeability by comparing the oxygen transmission rate measured at a scored location on the film sample with the oxygen transmission rate measured at a non-scored location on the film sample. The average data for each set is shown in Table 3, below, at 100% O₂, room temperature, and 85% relative humidity (carrier/permeant).

TABLE 3
Barrier Testing

| | Oxygen | Oxygen |
|---|---|---|
| | Transmission Rate | Transmission Rate |
| | (ml/100 in²/24 hours) | (ml/100 in²/24 hours) |
| Sample | With Score | Without Score |
| A | 1.01 | 1.23 |
| B | 1.25 | 1.25 |

As shown in Table 3, Samples A and B both exhibited oxygen transmission rates between about 1.00 and about 1.30 ml/100 in²/24 hours. Moreover, as shown in Table 3, the Samples A and B both exhibited oxygen transmission rates measured at the location of the score that were substantially similar to oxygen transmission rates measured at a non-scored location on the film.

### Example 4

A multi-layer film was prepared having a first outer layer comprising 36 gauge polyester disposed adjacent a first side of the encapsulation layer; an encapsulation layer comprising an EVOH barrier layer of about 0.15 mil thickness, with an encapsulation material comprising polyethylene (of about 0.2 mil thickness on each side of the EVOH layer) and a tie layer of acid-modified ethylene terpolymer (of about 0.01 mil thickness on each side of the EVOH layer; i.e. a 0.4 lb/ream) between the barrier layer and polyethylene layer; an inner layer comprising 55 gauge biaxially oriented polypropylene disposed adjacent a second side of the encapsulation layer; and a second outer layer comprising ethylene vinyl acetate (between 1.0-2.0 mils) disposed adjacent the inner layer. The film sample was approximately 3.0 mils thick.

The film web was scored with a LasX Industries LDM 100-5 model laser at varying laser power, as specified below. The film web was scored with continuous straight lines in the machine direction, using five lasers set up in parallel, generally following the process as shown in FIG. 3. The lasers were set at laser powers ranging from 20% to 39%, with five laser power values analyzed per sample run (i.e. the first sample used laser power settings of 20%, 21%, 22%, 23% and 24%; the second sample used power settings of 25%-29%, etc). The film web was scored for approximately 60 seconds while the web was running at a standard line speed of approximately 300-600 ft/min. The samples were analyzed for tensile strength using an Instron instrument model number 3369 and pulled at 2 inches per minute. The results are shown below in Table 4, using an unscored section of film as a control (0% score).

TABLE 4
Tensile Strength for the films of Example 4
Laser Score Tensile, Instron, Pulled at 2″/min, LBF

| | Maximum load | Extension @ |
|---|---|---|
| Score % | (lbs of force) | break, inches |
| 20% | 19.80 | 0.30 |
| | 19.32 | 0.29 |
| | 19.07 | 0.30 |
| | 19.21 | 0.30 |
| | 19.43 | 0.29 |
| Avg | 19.37 | 0.30 |
| 21% | 15.98 | 0.32 |
| | 15.75 | 0.33 |
| | 16.12 | 0.33 |
| | 16.11 | 0.35 |
| | 15.48 | 0.40 |
| Avg | 15.89 | 0.35 |
| 22% | 19.10 | 0.26 |
| | 15.75 | 0.17 |
| | 14.84 | 0.17 |
| | 19.24 | 0.27 |
| | 19.21 | 0.27 |
| Avg | 17.63 | 0.23 |
| 23% | 17.12 | 0.19 |
| | 16.36 | 0.19 |
| | 16.44 | 0.18 |
| | 16.75 | 0.19 |
| | 16.82 | 0.21 |
| Avg | 16.70 | 0.19 |
| 24% | 21.47 | 0.36 |
| | 20.99 | 0.35 |
| | 19.39 | 0.31 |
| | 21.58 | 0.36 |
| | 21.40 | 0.37 |
| Avg | 20.97 | 0.35 |
| 25% | 16.28 | 0.19 |
| | 15.75 | 0.17 |
| | 15.73 | 0.16 |
| | 15.55 | 0.17 |
| | 16.10 | 0.18 |
| Avg | 15.88 | 0.17 |
| 26% | 13.49 | 0.12 |
| | 13.92 | 0.13 |
| | 14.30 | 0.13 |
| | 14.13 | 0.13 |
| | 13.92 | 0.14 |
| Avg | 13.95 | 0.13 |
| 27% | 14.10 | 0.14 |
| | 14.21 | 0.15 |
| | 13.84 | 0.13 |
| | 13.99 | 0.13 |
| | 13.96 | 0.13 |
| Avg | 14.02 | 0.14 |
| 28% | 14.01 | 0.12 |
| | 12.52 | 0.10 |
| | 12.96 | 0.11 |
| | 12.97 | 0.10 |
| | 12.24 | 0.09 |
| Avg | 12.94 | 0.10 |
| 29% | 18.82 | 0.27 |
| | 18.25 | 0.25 |
| | 18.10 | 0.24 |
| | 18.86 | 0.28 |
| | 18.81 | 0.26 |
| Avg | 18.57 | 0.26 |
| 30% | 13.08 | 0.10 |
| | 13.31 | 0.11 |
| | 12.85 | 0.10 |
| | 12.93 | 0.10 |
| | 12.98 | 0.11 |
| Avg | 13.03 | 0.10 |
| 31% | 10.61 | 0.06 |
| | 10.05 | 0.05 |
| | 10.30 | 0.05 |
| | 9.82 | 0.05 |
| | 10.22 | 0.05 |
| Avg | 10.20 | 0.05 |
| 32% | 11.11 | 0.12 |
| | 11.06 | 0.11 |
| | 10.66 | 0.09 |
| | 10.59 | 0.09 |
| | 10.38 | 0.09 |
| Avg | 10.76 | 0.10 |
| 33% | 10.67 | 0.09 |
| | 11.30 | 0.12 |
| | 10.34 | 0.08 |
| | 10.88 | 0.10 |
| | 10.41 | 0.09 |
| Avg | 10.72 | 0.10 |
| 34% | 15.30 | 0.29 |
| | 15.44 | 0.29 |
| | 15.27 | 0.28 |
| | 15.41 | 0.28 |
| | 15.60 | 0.29 |
| Avg | 15.40 | 0.29 |
| 35% | 9.91 | 0.07 |
| | 9.56 | 0.06 |
| | 9.77 | 0.07 |
| | 9.80 | 0.06 |
| | 9.57 | 0.07 |
| Avg | 9.72 | 0.07 |
| 36% | 8.50 | 0.05 |
| | 8.17 | 0.05 |
| | 8.73 | 0.05 |
| | 8.67 | 0.05 |
| | 8.46 | 0.05 |
| Avg | 8.51 | 0.05 |
| 37% | 9.23 | 0.06 |
| | 8.85 | 0.05 |
| | 8.69 | 0.05 |
| | 9.27 | 0.06 |
| | 9.08 | 0.05 |
| Avg | 9.02 | 0.05 |
| 38% | 8.12 | 0.04 |
| | 7.82 | 0.04 |
| | 7.88 | 0.04 |
| | 7.90 | 0.04 |
| | 7.73 | 0.04 |
| Avg | 7.89 | 0.04 |
| 39% | 10.63 | 0.09 |
| | 11.56 | 0.12 |
| | 10.78 | 0.14 |
| | 11.47 | 0.15 |
| | 10.60 | 0.15 |
| Avg | 11.01 | 0.13 |

As shown in Table 4, both the maximum load and the extension at break values tended to be lower as the power of the laser increased.

A portion of the film samples of Example 4 were also tested for oxygen permeability by comparing the oxygen transmission rate measured at a scored location on the film sample with the oxygen transmission rate measured at a non-scored location on the film sample. The data for the film scored at each power setting is shown in Table 5, below, at 100% 0₂, room temperature, and 85% relative humidity (carrier/permeant).

TABLE 5
Barrier Testing
Oxygen Transmission Rate, ml/per 100 in2/24 hrs

| Score % | spcm1 | spcm2 | Avg |
|---|---|---|---|
| 0 | 1.451 | 1.388 | 1.420 |
| 20 | — | — | — |
| 21 | — | — | — |
| 22 | 1.238 | 1.298 | 1.268 |
| 23 | 1.390 | 1.461 | 1.425 |
| 24 | 1.148 | 1.218 | 1.183 |
| 25 | — | — | — |
| 26 | — | — | — |
| 27 | 1.408 | 1.347 | 1.378 |
| 28 | 1.238 | 1.280 | 1.259 |
| 29 | 1.274 | 1.237 | 1.256 |
| 30 | 1.510 | 1.433 | 1.471 |
| 31 | — | — | — |
| 32 | — | — | — |
| 33 | 1.341 | 1.419 | 1.380 |
| 34 | — | — | — |
| 35 | 1.381 | 1.433 | 1.407 |
| 36 | — | — | — |
| 37 | 1.285 | 1.362 | 1.324 |
| 38 | — | — | — |
| 39 | 1.278 | 1.405 | 1.341 |

100% O₂; 85% RH (carrier/permeant), RT, O₂ to Outside

As shown in Table 5, all of the samples tested exhibited oxygen transmission rates between about 1.18 and about 1.43 ml/100 in²/24 hours. Moreover, as shown in Table 5, all of the samples tested exhibited oxygen transmission rates measured at the location of the score that were substantially similar to oxygen transmission rates measured at a non-scored location on the film, regardless of the laser power used to generate the score.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

It will be understood by those having skill in the art that changes may be made to the details of the above-described embodiments without departing from the underlying principles presented herein. Thus, the embodiments described herein should not be used to limit the scope of the following claims. Recitation in the claims of the term “first” with respect to a feature or element does not necessarily imply the existence of a second or additional such feature or element.

1. A method for scoring a multi-layer film structure comprising,
obtaining a multi-layer film comprising at least one outer layer and an encapsulation layer,
wherein the encapsulation layer comprises an encapsulation material that encapsulates the barrier layer,
wherein the barrier layer comprises an oxygen impermeable material, and
laser scoring the multi-layer film structure such that the at least one outer layer of the multi-layer film structure is scored.

2. The method of claim 1, wherein the laser scores are continuous.

3. The method of claim 1, wherein the laser scores are discontinuous.

4. The method of claim 1, wherein the multi-layer film structure further comprises at least one paper layer.

5. The method of claim 1, wherein the barrier layer comprises EVOH.

6. The method of claim 1, wherein at least one outer layer comprises polyester.

7. The method of claim 1, wherein at least one outer layer comprises nylon.

8. The method of claim 1, wherein the multi-layer film structure further comprises a sealant layer.

9. The method of claim 8, wherein the sealant layer comprises ethylene vinyl acetate.

10. The method of claim 1, wherein the laser scoring is achieved by scoring the film with a plurality of lasers.

11. The method of claim 1, wherein the laser scoring is achieved by scoring the film in a plurality of locations such that the laser scores are substantially parallel to each other.

12. The method of claim 1, wherein the laser scoring of the at least one outer layer generally lies in a plane substantially perpendicular to a plane of the multi-layer film.

13. The method of claim 1, wherein the scored multi-layer film has an OTR of less than about 3.0 ml/100 in²/24 hr.

14. A method for scoring a multi-layer film structure comprising,
obtaining a multi-layer film comprising
an outer layer comprising at least one of polyethylene or nylon;
an encapsulation layer comprising a barrier layer;
wherein the encapsulation layer comprises a polyethylene layer that encapsulates the barrier layer; and
laser scoring the multi-layer film structure such that the outer layer of the multi-layer film structure is scored, wherein the scored multi-layer film has an OTR of less than about 3.0 ml/100 in²/24 hr.

15. The method of claim 14, wherein the encapsulation layer further comprises a tie layer that encapsulates the barrier layer.

16. The method of claim 14, wherein the barrier layer comprises EVOH.

17. The method of claim 14, wherein the laser scores are continuous.

18. The method of claim 14, wherein the laser scores are discontinuous.

19. The method of claim 14, wherein the multi-layer film structure further comprises at least one paper layer.

20. The method of claim 14, wherein the laser scoring is achieved by scoring the film with a plurality of lasers.

21. The method of claim 14, wherein the laser scoring is achieved by scoring the film in a plurality of locations such that the laser scores are substantially parallel to each other.

22. The method of claim 14, wherein the laser scoring of the at least one outer layer generally lies in a plane substantially perpendicular to a plane of the multi-layer film.

23. The method of claim 14, wherein the scored multi-layer film has an OTR of less than about 2.0 ml/100 in²/24 hr.

24. A method for scoring a multi-layer film structure comprising,
obtaining a multi-layer film comprising
a first outer layer comprising at least one of polyethylene or nylon;
an encapsulation layer comprising a barrier layer, the barrier layer comprising EVOH;
an inner layer comprising oriented polypropylene;
a second outer layer comprising a sealant layer, the sealant layer comprising ethylene vinyl acetate;
wherein the encapsulation layer comprises a polyethylene layer that encapsulates the barrier layer; and
laser scoring the multi-layer film structure such that the outer layer of the multi-layer film structure is scored, wherein the scored multi-layer film has an OTR of less than about 3.0 ml/100 in²/24 hr.

25. The method of claim 24, wherein the encapsulation layer further comprises a tie layer that encapsulates the barrier layer.

26. The method of claim 24, wherein the laser scores are continuous.

27. The method of claim 24, wherein the laser scores are discontinuous.

28. The method of claim 24, wherein the multi-layer film structure further comprises at least one paper layer.

29. The method of claim 24, wherein the laser scoring is achieved by scoring the film with a plurality of lasers.

30. The method of claim 24, wherein the laser scoring is achieved by scoring the film in a plurality of locations such that the laser scores are substantially parallel to each other.

31. The method of claim 24, wherein the laser scoring of the at least one outer layer generally lies in a plane substantially perpendicular to a plane of the multi-layer film.

32. The method of claim 24, wherein the scored multi-layer film has an OTR of less than about 2.0 ml/100 in²/24 hr.
